(19) United States
(12) Patent Application Publication
(10) Pub. No.: US 2018/0065073 A1
(43) Pub. Date: Mar. 8, 2018

(54) PROCESS FOR MAKING SOLID PARTICLES

(71) Applicant: The Procter & Gamble Company, Cincinnati, OH (US)

(72) Inventors: Geoffrey Marc Wise, Reading, OH (US); Ioannis Constantine Constantinides, Wyoming, OH (US)

(21) Appl. No.: 15/682,842

(22) Filed: Aug. 22, 2017

Related U.S. Application Data
(60) Provisional application No. 62/378,362, filed on Aug. 23, 2016.

(51) Int. Cl. B01D 47/02; B01D 47/04; B01D 9/00; C07B 63/02; C09B 67/02; C09B 67/54

(52) U.S. Cl. CPC B01D 47/021; B01D 47/04; B01D 9/0036; C09B 67/0096; C07B 63/02; C09B 67/0097; B01D 9/0063

(57) ABSTRACT

The invention relates to a process of creating particles of controlled size by creating them in the interstitial regions in a continuous liquid phase that contains a second, inert gas phase at high volume fraction; namely a foam. The second phase creates a physical barrier that limits the aggregation of formed particles beyond the size of the narrow interstitial regions occupied by the continuous phase. This technique is useful when the particles normally create large aggregates due to the fast nature of the reaction and the strong attractions between the formed particles, and for enhancing the deposition of high-value materials by connecting them to coacervates of controlled size.

### FIELD OF THE INVENTION

The invention relates to a process of forming solid particles of a controlled size by utilizing a continuous process.

### BACKGROUND OF THE INVENTION

The invention relates to a method of making solid particles of a controlled size via a continuous process. The types of materials that may be made using the method include particles that are used in pharmaceuticals, personal care compositions, as well as in other industries. They may be inorganic particles, such as insoluble salts of calcium, copper, magnesium, zinc or other multivalent metals, or they may be organic particles, by which we mean materials that have a high content by weight of carbon, such as about 10 to about 95%.

Particles, which may be crystals or may include crystals, of a target particle size are often desired due to their short dissolution times, high bioavailability, improved color value and minimal impact on product texture and appearance, as well as for compliance with safety and regulatory restrictions. Therefore, the desired particle size typically falls between about 0.1 micrometers (μm) and about 100 μm, alternatively between about 0.15 and about 10 μm. Precipitation (which can be crystallization) methods to produce particles are, however, a difficult process to control and scale up due to the complicated and often rapid processes of nucleation, growth and agglomeration that can be quite sensitive to formulation and process variables. Traditional methods for precipitation of materials useful in the pharmaceutical industry include precipitation from solution via cooling or addition of a precipitating agent, such as an anti-solvent, as well as combination of two soluble components to form an insoluble complex. However, traditional methods for forming solid particles continue to result in particles with significant size variability, are complex and costly that may require purification steps and/or may be limited to sequential batch process operations which are not easily scaled up as part of an industrial process. Therefore, there remains the need for an inexpensive, simple, broadly-applicable industrially feasible process for making particles (which may be crystals) in the 0.1-100 μm size range.

### SUMMARY OF THE INVENTION

The invention relates to a method of making solid particles comprising: adding a precursor material to a liquid to form a liquid stream, wherein the concentration of precursor material is from about 2% to about 99% by weight of the liquid stream; adding an inert gas stream into the liquid stream of step a, resulting in a gas-liquid mixture having a gas volume fraction from about 30% to about 98% and an average Sauter mean bubble diameter of about 0.2 to about 200 μm; and transforming the precursor material physically or chemically, resulting in the formation of solid particles.

### BRIEF DESCRIPTION OF THE DRAWINGS

FIG. 1 is a Horiba graph depicting particle size distribution of zinc pyrithione particles produced at different air pressures.

FIG. 2 is a Zeiss Axioscope 400× polarized microscopy image of zinc pyrithione (ZPT) crystals produced at an air pressure of 0 psi.

FIG. 3 is a Zeiss Axioscope 400× polarized microscopy image of zinc pyrithione (ZPT) crystals produced at an air pressure of 10 psi.

FIG. 4 is a Zeiss Axioscope 400× polarized microscopy image of zinc pyrithione (ZPT) crystals produced at an air pressure of 30 psi.

FIG. 5 is a Horiba graph depicting particle size distribution of zinc carbonate particles produced at different air pressures.

FIG. 6 is an image of Zeiss Axioscope at 400× (cross polar microscopy) of a zinc carbonate sample taken at 0 psi air pressure.

FIG. 7 is an image of Zeiss Axioscope at 400× (cross polar microscopy) of a zinc carbonate sample taken at 10 psi air pressure.

FIG. 8 is an image of Zeiss Axioscope at 400× (cross polar microscopy) of a zinc carbonate sample taken at 30 psi air pressure.

FIG. 9 is a polarized microscopy image (Zeiss Axioscope, 400× magnification) of particles created from the contact of a zinc pyrithione solution with diluted polyquaternium-6 at an air pressure of 5 to 10 psi.

FIG. 10 is a polarized microscopy image (Zeiss Axioscope, 400× magnification) of particles created from the contact of a zinc pyrithione solution with diluted polyquaternium-6 at an air pressure of 20 psi.

FIG. 11 is a schematic drawing of the method of making particles of behenyl alcohol.

FIG. 12 is a schematic drawing of the method of making particles of polyquaternium-10 coacervated with sodium laureth sulfate.

### DETAILED DESCRIPTION OF THE INVENTION

### A. Definitions

SOLID as used herein means a substance that has a definite volume and shape and resists forces that tend to alter its volume or shape.

PRECIPITATION as used herein means a process of producing solid particles having controlled particle size within a liquid phase.

CRYSTALLINE as used herein means a material in which the constituent atoms are arranged in a three-dimensional lattice, periodic in three independent directions.

CRYSTALLIZATION as used herein means a process that produces a crystalline material.

SURFACTANT as used herein means a molecule with amphiphilic character, in which one part of the molecule has affinity for hydrophobic oil and another part of the molecule has affinity for water.

PERSONAL CARE PRODUCT as used herein means a consumer product applied to part of the human body for cosmetic purposes, such as cleaning or altering the appearance or feel of that part of the body.

LIQUID as used herein means a state of matter intermediate between that of crystalline substances and gases in which the substance has the capacity to flow under extremely small shear stresses and conforms to the shape of a confining vessel, but it is relatively incompressible, lacks the capacity to expand without limit and can possess a free surface.

PRECURSOR MATERIAL as used herein means a material that can be converted into a collection of solid particles of controlled size using a method that includes either (a) a reaction with another material or (b) a physical process.

LIQUID STREAM as used herein means the combination of a precursor material and a liquid that flows through a confining geometry or conduit, such as a pipe, at a specified mass flow rate that can be expressed in convenient units, such as grams per minute. The combination of liquid stream and the precursor material may be a solution of a precursor material in the liquid or a dispersion of the precursor material in the liquid; in the latter case, the particles of precursor material in the dispersion have a wide size distribution which will be transformed to a narrower size distribution by the precipitation process.

INERT GAS as used herein means a gaseous phase that does not contain molecules that react chemically with the precursor material in the liquid stream to form molecules of a different molecular composition.

GAS or GASEOUS PHASE as used herein means a compressible state of matter characterized by low density, typically less than about 0.1 kilograms per liter, and low viscosity, typically less than about 0.0001 Pa s. The gaseous phase may contain a single molecular species, such as ethane, or a mixture of gaseous components, such as air. Examples of gases at 20° C. and 1 bar absolute pressure include air, oxygen, nitrogen, and methane.

CONTINUOUS PROCESS as used herein means a process in which the raw materials are delivered continuously into a physical volume of constant dimensions, and the resulting product is continuously removed from this volume. The composition, temperature, and pressure of the volume remains substantially unchanged during the time that the process is operating.

PARTICLES as used herein means distinct pieces of solid matter that substantially retain their shape and size when dispersed in a non-dissolving liquid.

### B. Description of the Method

Precipitation of materials from gas-liquid mixtures (i.e. foams) may offer an appealing approach to making particles of controlled size because of a controllable interstitial space between the bubbles in the foam where solid particle can exclusively form in these mixtures. Historically, one of the key barriers to implementing foam-based precipitation on an industrial scale is that the batch methods of forming the bubbles during the precipitation/crystallization process, as exemplified by WO200072934 and US20050218540, do not lend themselves to efficient scale-up. These processes begin by carefully aerating a liquid in a batch vessel until a very high (often in excess of 98%) volume fraction of air in the batch vessel is attained, followed by the initiation of a triggering mechanism to create particles in the narrow interstitial regions of liquid between the air bubbles. The very high volume fractions of air in the foam are a useful to prevent the pockets of precursor material from interacting to form undesired larger particles after the triggering step.

The process described herein is one wherein (1) a precursor material is added into a liquid to create a liquid stream, (2) an inert gas is added to the liquid stream, (3) the inert gas is subdivided into bubbles of the desired size to create a gas-liquid mixture (foam), and (4) the resulting gas-liquid mixture is contacted with a second stream to effect the particle formation. The process can occur in a rapid, single-pass continuous process, thereby enabling an efficient production of particles on an industrial scale. What has been surprisingly found is that the extremely high volume fractions (above about 90%, often in excess of about 98%) in the prior batch-based processes are not needed when a continuous process is used to generate the foam and subsequently effect the production of particles inside the foam. It has been found that more modest volume fractions of the gaseous phase, such as about 30% to about 98%, alternatively from about 40% to about 90%, are sufficient for achieving the desired control of the size of the desired particles in a continuous process. It has been found that these volume fractions are often readily achieved with conventional aeration techniques, in contrast to the laborious batch processes described in prior art to achieve the very high volume fraction of gaseous phase. Moreover, these more modest volume fractions of gaseous phase translate into easier distribution of mass or energy into the foam as needed for the triggered formation of the particles after the foaming step, resulting in the continuous mode of particle formation. The process includes the following elements: a liquid stream containing a precursor material to be converted to particulate form, a gaseous phase that is introduced into the liquid and subsequently divided into bubbles, and a trigger for the particle-forming reaction, which occurs in the presence of the newly formed bubbles. In a continuous process, these steps can be placed in the proper order by proper configuration of the network of pipes or conduits containing the material streams.

1. Liquid Stream

A precursor material is added to the liquid to form a liquid stream. The precursor material may include any material that can be precipitated or crystallized out as particles of a controlled size. The precursor material includes, but is not limited to an organic material such as a pharmaceutical active ingredient or biological extract or a component of a dye or pigment or a metallic salt. The precursor material can be included at a level of from about 0.5% to about 99% by weight of the precursor material. The precursor material can be included at a level of from about 1% to about 20% by weight, from about 2% to about 15% by weight, and from about 5% to about 10% by weight. The liquid stream may be primarily aqueous, organic, polymeric, metallic, or a mixture thereof. An aqueous liquid stream that is at least 50% by weight water is useful due to the relatively low cost and high availability of water for industrial processes. The liquid stream may include a solvent or a combination of solvents. The liquid stream may include water as a carrier or an aqueous carrier which is a mixture of water and a cosolvent. Cosolvents can be water-miscible solvents, including but not limited to, ethanol, ethylene glycol, dipropylene glycol, glycerin, propylene glycol and combinations thereof. The precursor material is added to the liquid. This precursor material is precipitated or crystallized out as a particle in a later step in the production process.

2. Introduction of the Inert Gas to the Liquid Stream

Gas is added into the liquid stream. The result of the combination of inert gas and the liquid stream is a foam. Hereinafter gas-liquid mixture and foam are considered synonymous. The resulting gas-liquid mixture has a gas volume fraction of from about 30% to about 98%, from about 35% to about 95%, from about 40% to about 90%, and from about 40% to about 80% from about 50% to about 85% and from about 60% to about 80%. Additionally, the resulting gas-liquid mixture has an average Sauter mean bubble diameter of about 0.2 μm to about 200 μm, from about 1 μm to about 100 μm, and from about 2 μm to about 50 μm. The gas used to create the bubbles may be any inert gas, and can include air, oxygen, nitrogen, argon, carbon dioxide, volatile hydrocarbons, and mixtures thereof. Air, or its natural components (nitrogen, oxygen, argon, carbon dioxide), is particularly suitable as it is inexpensive, its volume fraction is easily manipulated by the fluid pressure, and it is easily removed in a subsequent de-aeration step. Other gases with low solubility in the liquid stream, such as light hydrocarbons, may also be suitable if an apparatus is included to separate out the gas after the particle-forming reaction, for later recycling back into the production process. The process described herein is distinct from traditional methods utilizing small bubbles of CO₂ or other gases that react to form particles of suitable morphology, in that for the process described herein the gas phase does not participate in the reaction; it merely influences the size of the domains where the precipitation process takes place.

Any method/process for introducing the gas into the liquid stream may be used. For example, the foam-generating machines used in the marshmallow-making industry and other food manufacturing processes may be used. For small bubble sizes, a “micro bubble generator” as described in the Chem. Eng. Journal 174 (2011), pp. 413-420 by Bang et al., entitled “Precipitation of calcium carbonate by carbon dioxide microbubbles” may be suitable. Alternatively, the gas may be sparged, or passed through a frit, screen or mesh, as commonly practiced to deliver oxygen into aquatic environments, or any other commonly used method for injecting gas into liquids. This gas introduction step is preliminary to a bubble control step as outlined below.

3. Control of Gas Volume Fraction and Bubble Size

For industrial-scale application static mixers are suitable to sub-divide the gas phase and distribute it evenly in the liquid stream. Suitable static mixers include orifice plates, expansion/contraction zones, and static mixer designs, including but not limited to those sold by Sulzer and Chemineer corporations. The bubble size can be controlled by process variables such as the interfacial tension between the gas and liquids, the relative mass flow rates of the gas and liquids, their viscosities, and the geometry of the static-mixing device. An additional process control variable is the absolute pressure of the tube containing the gas-liquid mixture, as the gas-phase volume will depend inversely on this pressure. The lower absolute pressures can reduce the mass flow rate of gas used to create the desired foam structure. A pressure-control device such as a pump or rotor-stator mixer downstream of the static mixer can be used to independently control the gas phase volume, which also influences the resulting bubble size. General correlations for bubble sizes as a function of process conditions can be found in compilations such as the Handbook of Industrial Mixing, published by John Wiley and Sons.

A surfactant may be introduced into the liquid stream that receives the dispersed gas phase, as the surfactant plays a useful role in controlling and stabilizing the size of the bubbles. Any of the known classes of surfactants, including anionic, cationic, nonionic, and zwitterionic surfactants may be used, based on the compatibility with the precursor materials and resulting particles. Since the bubbles are only formed temporarily just before the precipitation, only a relatively low level, if any, of surfactant is useful—just enough to stabilize the bubbles long enough for the particle forming step. In fact, a high level of surfactant may interfere with a deaeration step (vacuuming, centrifugation, etc.) contemplated after the completion of the particle-forming step. The surfactant level can be from about 0 to about 5%, from about 0.1 to about 1, from about 0.5 to about 1 by weight of the liquid stream.

In the case of spherical bubbles the gas volume fraction of the gas phase can be from about 30% to about 98%, from about 35% to about 95%, from about 40% to about 90%, from about 40% to about 74%, from about 30% to about 70%, from about 40% to about 70%, and from about 40% to about 80%. Lower gas volume fractions may provide some steric hindrance, but will not be as effective in creating narrow regions of continuous phase that are helpful in limiting the size of the formed solid particles. Gas volume fractions of spherical bubbles above about 74% and a unimodal distribution create a “high-internal-phase” foam with narrow struts connecting pockets of continuous phase of diameter roughly about 0.1 to about 0.4 times the diameter of the droplets. Higher gas volume fractions of gas phase may create thinner connecting channels between the pockets, such that particles that bridge these interstitial regions may be more easily broken by an optional moderate shearing step downstream of the particle formation or crystallization step. Higher gas volume fractions may also tend to helpfully narrow the particle-size distribution. Gas volume fractions above about 90% can be more difficult to process due to their higher rheology and poor stability; foams with high volume fractions are susceptible to a phase separation in which the gas phase coalesces, breaking the foam.

The characteristics of the foam, including gas volume fraction and bubble size, can be determined using conventional techniques including but not limited to, inline microscopy, conductivity, magnetic resonance imaging, pressure measurements, and flow meters. A way of measuring the gas volume fraction is by comparing the specific volume (inverse of the density) of the foamed material to that of the unfoamed liquid stream. A way of measuring the bubble size in a continuous process is to insert a microscopic camera into the process, and analyze the resulting image for bubble size, as exemplified by the Canty Liquid Particle Size Analyzer (J. M. Canty, Buffalo, N.Y.). An alternate way that often works for more concentrated foams is to insert a Lasentec FBRM-PVM probe (Mettler Toledo, Columbus, Ohio). This device measures the chord length between interfaces in the foam, which can be transformed into an estimate of the bubble size distribution based on geometric considerations. The foam characteristics can also be sometimes inferred from inline rheology measurement, using correlations for concentrated foam rheology as published in the literature; e.g. H. M. Princen and A. D. Kiss: “Rheology of Foams and Highly Concentrated Emulsions.” J. Colloid Interface Sci. 112,427 (1986) and references therein.

The size of the produced particles (or crystals) is related, among others, to the bubble size and concentration of the precursors in the liquid stream. For the process to be industrially relevant, the precursor concentration will be typically greater than about 2% by weight, and less than about 99% by weight. As mentioned previously, the gas volume fraction at the point of the particle-forming reaction or crystallization can be above 30% and less than about 98%. Therefore, from geometric considerations, the desired bubble diameter will be somewhat larger than the desired particle size. In typical situations, the bubble diameter may be somewhere between 1.5 times and 10 times the approximate diameter of the formed particles, this may result in bubble diameter of from about 0.2 to about 200 microns.

4. Precipitation Step to Form the Desired Particles

Once the foam has been created, the precipitation (particle forming) step can proceed quickly via any means to form the desired particles. An anti-solvent such as an electrolyte or alcohol can be added to precipitate out a solid which is previously dissolved. Alternatively, the introduction of another dissolved species can cause a particle formation via a reaction or interaction between species. For example, precipitation may be achieved by mixing together cationic with anionic species. Examples of these include particles that are formed quickly when a metallic cation such as copper, zinc, magnesium and calcium contact certain anions such as carbonates. Other examples of particle forming interactions include coacervates or liquid crystals which can form between cationic polymers and anionic surfactants, either as a result of direct contact or after subsequent dilution with water. Alternatively, a change in temperature or pH in the liquid part of the foam can induce the precipitation and/or crystallization of one of its components.

Some mixing energy is generally useful to intimately mix the foam in order to generate the desired particles, but the presence of the bubbles will generally reduce the energy input used to avoid undesirable agglomeration. Any of the traditional mixing devices may be used for this purpose, such as high-pressure homogenizers, colloid mills, rotor-stator mills, static mixers, orifice plates, etc. Rotor-stator devices are suitable as they may provide an independent method of controlling the absolute pressure in the precipitation zone, to advantageously control the bubble volume fraction as discussed above.

Since the foam is formed via a continuous process, there is no need for a time delay between the creation of the foam and the particle-forming step. In fact, it may be advantageous to reduce this time as much as possible, both to minimize the time for foam stabilization, and to simplify the production process. This time between the formation of the foam (addition of gas into the liquid stream) and the onset of precipitation can be shorter than 10 seconds, shorter than 8 seconds, shorter than 5 seconds, alternatively shorter than 2 seconds.

For some product applications, markedly non-spherical particles are desired for their enhanced surface area per volume, interfacial properties, and the like. The shape of the particles formed in the semi-confined regions of continuous phase may depart significantly from spherical, particularly at high volume fractions of gas phase and high concentrations of the precursor material. Both spherical and substantially aspherical particles are potential results of the process described herein.

Sequential process steps can be performed in the confined spaces, so as to make new composite structure particles by adding one (or more) additional component which is incorporated to the recently formed particles. In other words, the continued presence of the gas phase may enable the production of a composite structure of a controlled morphology that would otherwise be difficult to create in the absence of the sterically hindering gas phase. For example, cationic polymers with charge densities of about 1.0 to about 20 meq/gram can, under certain circumstances, bind strongly to particles that are themselves anionically charged, or made so by the introduction of an anionic dispersant. The use of a process which creates and disperses bubbles of the desired size and volume fraction, as described herein, makes it more feasible to create these composite processes on an industrial scale.

In the case of a precipitation reaction, such a sequence of events can be represented by:

A+B+I→AB+I

AB+I+C→AB−C

Where I represents the gas phase (inert gas), A and B are the two components which combine (react or interact) to form an insoluble compound in the liquid phase of the foam, and C is the later component to be connected to the newly formed AB particle. The continued presence of the gas phase limits the formation of an undesired AB-C-AB-C-AB-C agglomerate.

In a similar fashion, when the particle is formed from a single, precursor material A, the sequence of events can be represented by:

A(soluble)+I+NS→A(solid)+I+NS

A(solid)+I+C→A−C

Where NS refers to an antisolvent or any other change, such as cooling, which induces A to become solid. It is possible that the initially formed liquid stream (that contains a liquid and the precursor material) is a solution of the precursor material. It is also possible that the initially formed liquid stream contains the precursor material in both a soluble and an insoluble (particle) form.

Although the use of the gas phase may be most useful in a continuous process, where the particle size and volume fraction of the second phase need only be controlled for a short time, a batch or semi-continuous process is also possible, where the gas phase is dispersed into a vessel.

The presence of the gas phase can allow control of the morphology of the particle formation that can occur upon contact between positively and negatively charged materials. For example, highly charged cationic polymers can complex with anionically charged surfactants to create an insoluble complex that may deposit readily on a target surface, such as a conditioning agent including, but not limited to, silicones, fatty alcohols, organic oils and combinations thereof. In the absence of a gas phase, a high dispersive energy is can be used during the contact of the two reactants to prevent large agglomerates from forming, particularly at high concentrations of the reactants. The presence of the gas phase is useful when it is desired to attach a polymer to a surfactant of opposite charge when the surfactant is bound to a previously formed particle of interest, such as a pharmaceutical active, for enhanced delivery of that active. The presence of the gas phase suppresses the bridging mechanism that might otherwise result in an agglomerated network of polymer with the particle of interest.

5. Additional Process Steps

Downstream from the precipitation step of the process, one or more additional steps may be added such as (a) foam removal, (b) filtration, (c) spray drying, etc. Removal or reducing the gas phase of the gas-liquid mixture of foam may be achieved either via application of reduced pressure or via addition of a defoaming agent. The defoamer agent can be selected from the following classes: (a) nonionic surfactants such as acetylenic diols; (b) powder defoamers, including but not limited to silica particles, hydrophobically modifies or unmodified; (c) oil defoamers, including but not limited to mineral oils, vegetable oils, or other types of oil, which are insoluble in the liquid stream carrier; (d) waxes in oil carrier; the wax can be selected from paraffins, fatty esters, fatty alcohols, fatty acids, and other materials; (e) silicone fluid emulsions; (f) polyethylene glycols or polypropylene glycols or polyethylene-polypropylene copolymers or mixtures thereof; (g) other polymeric materials such as polyacrylate homopolymer or copolymers or other defoamers. Suitable defoamers or foam breaking materials can be found in the following references: (a) Kirk-Othmer Encyclopedia of Chemical technology, Third Edition, Volume 8, pages 236-254, Wiley, 2001; (b) Defoaming: Theory and Industrial Application, Ed. P. R. Garrett, Marcel Dekker, N.Y., 1993; (c) The Science of Defoaming: Theory, Experiment and Applications, Ed. P. R. Garrett, CRC Press, 2013.

### C. Types of Particles Formed

1. Transition-Metal Salts of Suitable Size

Anti-microbial particles, such as zinc and copper salts, are generally more effective in personal-care compositions at sizes from about 0.1 μm to about 10 μm, alternatively from about 0.1 μm to about 5 μm, alternatively from about 0.3 to about 10 μm, alternatively from about 0.3 μm to about 5 μm. Anti-microbial particles in this size range can have more efficient deposition, greater bioactivity, and improved consumer-noticeable attributes such as feel. There are several traditional ways of making these materials, including direct crystallization of the desired particle size and shape from a bulk solution, precipitation from the internal phase of an emulsion, and creation of large particles that are then reduced in a subsequent grinding, milling, or other particle-size reduction process. Each of these processes has undesired aspects such as restrictions to particular chemistries and equipment/processes that are expensive and difficult (inefficient).

The process described herein minimizes these difficulties by introducing a second, inert internal phase in one of the reactant streams prior to the precipitation or crystallization reaction. The presence of this phase presents a physical barrier to the formation of large particles; any larger particles formed are easily fractured due to the very thin connections between them that were formed in the narrow regions between the bubbles or droplets of the inert phase.

2—Enriched Coacervates

Manufacturers of consumer products has used high-charge-density cationic polymers, such as polyDADMAC (polyquaternium-6) to form liquid crystals in shampoo by mixing DADMAC with anionic surfactant (e.g. sodium laureth sulfate)—[e.g. US20080206355A1]. These “in-situ” coacervates function like traditional coacervates in that they deposit on surfaces of interest (skin, hair, scalp), and frequently act as deposition aids by bringing nearby particles (silicone droplets, anti-microbial actives, etc.) with them to the target surface, but unlike coacervates created by the consumer during the rinsing step, they are pre-formed by the manufacturer of the personal-care composition.

It is desired to control the particle size of the in-situ coacervates to from about 0.1 to about 50 μm, alternatively from about 0.5 to about 10 μm for consumer feel benefits, maintenance of lather, etc., but has been traditionally difficult to achieve due to the strong driving force of forming the cationic-anionic complex. Variables such as the mixing energy during the contact of the cationic polymer with the anionic surface, and the composition (electrolyte, surfactant level, etc.) of the medium are helpful, but it is still difficult to maintain the particles in the desired size range without objectionable agglomeration.

Furthermore, when the coacervate particles are tasked with depositing other materials, it is desired to enrich the relative concentration of the materials to be deposited relative to the coacervate, so as to effect a greater deposition of the high-value materials (HVM). HVMs include, but are not limited to, conditioning agents and pharmaceutical actives, ZPT, antidandruff agents and combinations thereof. The interstitially controlled particle formation process of the present invention has additional value when the particle formation occurs in the presence of an enhanced concentration of the HVM relative to their composition in the bulk, thus enriching the concentration of the HVM in the deposited floc.

3—Pigments

The process described herein can be used for the continuous manufacturing of insoluble organic pigments having controlled particle size. The organic pigment manufactured by the process can be an azo pigment, made by the reaction of a diazo compound of an aromatic amine and a coupler compound via an aromatic electrophilic substitution reaction. The process can be used to manufacture metalized azo pigments and nonmetallized azo pigments.

Non-limiting examples of nonmetallized azo pigments include Pigment Yellow 12, Pigment Yellow 13, Pigment Yellow 14 and Pigment Yellow 17. These pigments are products of a sequence of reactions starting from an aniline derivative, in these cases 3,3′-dichlorobenzidine (Compound I), diazotization using nitrous acid and a mineral acid to give a tetraazo compound (Compound IA) which is subsequently reacted with acetoacetanilide or derivatives of acetoacetanilide (Compound II) to give the pigment.

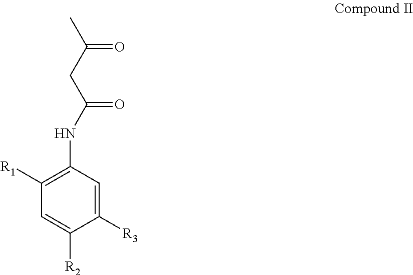

wherein R₁, R₂ and R₃ can be a selected from the groups consisting of —H, —Cl, methyl, and methoxy group, and wherein R₁, R₂ and R₃ can be the same or different functional groups.

The complete reaction scheme is provided in the Reaction Scheme of Example 5 (see below).

| | Product of the reaction between tetraazo |
|---|---|
| Pigment | Compound IA Compound I and Compound II |
| Pigment Yellow 12 | Compound II wherein R1 is hydrogen and R2 is |
| | hydrogen |
| Pigment Yellow 13 | Compound II wherein R1 is methyl group and R2 is |
| | methyl group |
| Pigment Yellow 14 | Compound II wherein R1 is methyl group and R2 is |
| | hydrogen |
| Pigment Yellow 17 | Compound II wherein R1 is methoxy group and R2 |
| | is hydrogen |

Metalized pigment can be prepared by a sequence of reactions starting from aniline derivatives (Compound III), diazotization using nitrous acid and a mineral acid to give a diazo compound, which can be reacted with phenol, phenol derivatives, naphthol, or naphthol derivatives to give a diazo dye, which is further reacted with a metal salts, such as calcium magnesium, barium or strontium salts, to give the final pigment. Naphthol and naphthol derivatives can be represented by Compound IV.

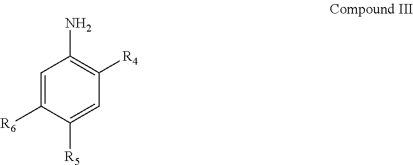

wherein R₄, R₅ and R₆ can be a selected from the groups consisting of —H, —Cl, methyl, methoxy, —SO₃M, —CO—NH₂, and —NO₂
and wherein R₄, R₅ and R₆ can be the same or different functional groups,
and wherein M can be selected from —H and alkali metal ion.

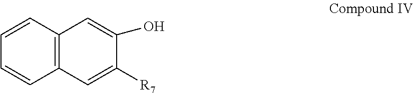

wherein R₇, can be a selected from the groups consisting of —H, —COOM, and COR₈,
and wherein R₈ can be represented by the chemical formula

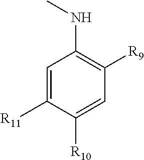

wherein R₉, R₁₀, R₁₁ can be selected from the group containing —H, —Cl, methyl, methoxy and ethoxy,
and wherein R₉, R₁₀, R₁₁ can be the same or different functional groups,
and wherein M can be selected from —H and alkali metal ion.

Non-limiting examples of aniline derivatives (Compound III) are 2-amino-5-methylsulfonic acid and 2-amino-4-chloro-5-methylsulfonic acid. More specifically, Pigment Red 48:2 is the product of the reaction between the diazo reaction of 2-amino-4-chloro-5-methylsulfonic acid and 3-hydroxy-2-napthoic acid, further reacted with a soluble calcium salt such as calcium chloride. Analogously, Pigment Red 57:1 is the product of the reaction between the diazo compound of 2-amino-5-methylsulfonic acid and 3-hydroxy-2-napthoic acid, further reacted with a soluble calcium salt such as calcium chloride. This reaction is represented in the scheme below.

Reaction Scheme for the Manufacturing of Pigment Red 57:1

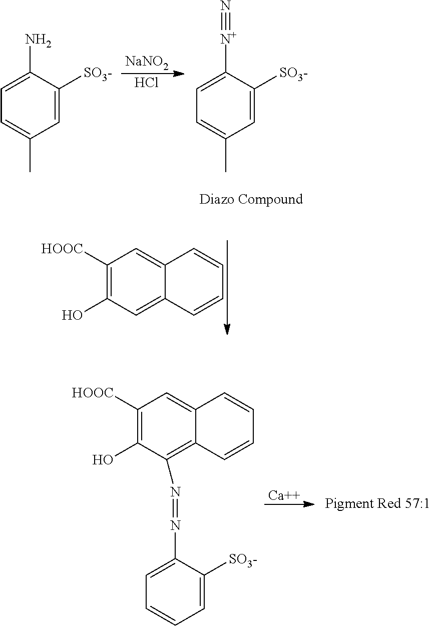

### EXAMPLES

The following examples illustrate embodiments of the invention described herein. All parts, percentages, and ratios herein are by weight unless otherwise specified. Some components may come from suppliers as dilute solutions. The amount stated reflects the weight percent of the active material, unless otherwise specified.

| | | Gas | Precipitation | |
|---|---|---|---|---|
| Exp# | Precursor Material | Phase | mechanism | Particle formed |
| 1 | Zinc sulfate | Air | Sodium | Zinc pyrithione |
| | | | pyrithione | |
| 2 | Zinc sulfate | Air | Sodium carbonate | Zinc carbonate |
| 3 | Sodium laureth | Air | Polyquaternium-6 | Polymer-surfactant liquid |
| | sulfate | | | crystals |
| 4 | Zinc pyrithione | Air | Polyquaternium-6 | Composite particles of liquid |
| | | | | crystals joined to ZPT |
| 5 | Dye precursor | Air | Diazo | Pigment particle |
| 6 | Behenyl alcohol | Air | Cooling | wax particles |
| 7 | Water, cationic polymer + | Nitrogen | Additional water | Polymer-surfactant coacervate |
| | anionic surfactant | | | |

### Example 1

A solution of about 30% zinc sulfate and about 1% active sodium laureth sulfate by weight in water is pumped via syringe pump to one incoming branch of a tee at about 100 g/min, wherein the internal diameter of the tee is about 6 cm. By a tee, we mean a conduit that has three apertures for material streams to flow into or out of the conduit. In most of our applications, two distinct materials are directed into two of the apertures of the tee and their combination exits through the third aperture. Compressed air at gauge pressures of about 0 to about 30 pounds per square inch (psi) is permitted to enter the second incoming branch of the tee through a Grreat Choice™ aquarium airstone frit, and the outlet of the tee is connected to 12 elements of 6-mm SMX static mixer (Sulzer, Switzerland). The foam downstream of the static mixer is connected to an inlet to a tee into a IKA Magic Lab rotor-stator mill (IKA Works, Wilmington, N.C., USA), where the second inlet to the tee into the mill is connected to a 6-cm pipe conveying about 115 g/min of about 40% sodium pyrithione solution using another syringe pump. The contact point of the two streams is placed just upstream of the high-shear zone of the mill, which is operated at a speed of about 15000 rpm. The particle containing mixture of the mill is collected and sampled into a sodium laureth sulfate solution for particle size analysis on a Horiba LA-950 particle-size analyzer. The resulting volume-averaged particle sizes are as follows:

| Air pressure | Median particle size |
|---|---|
| 0 psi | 1.620 μm |
| 10 psi | 0.482 μm |
| 30 psi | 0.236 μm |

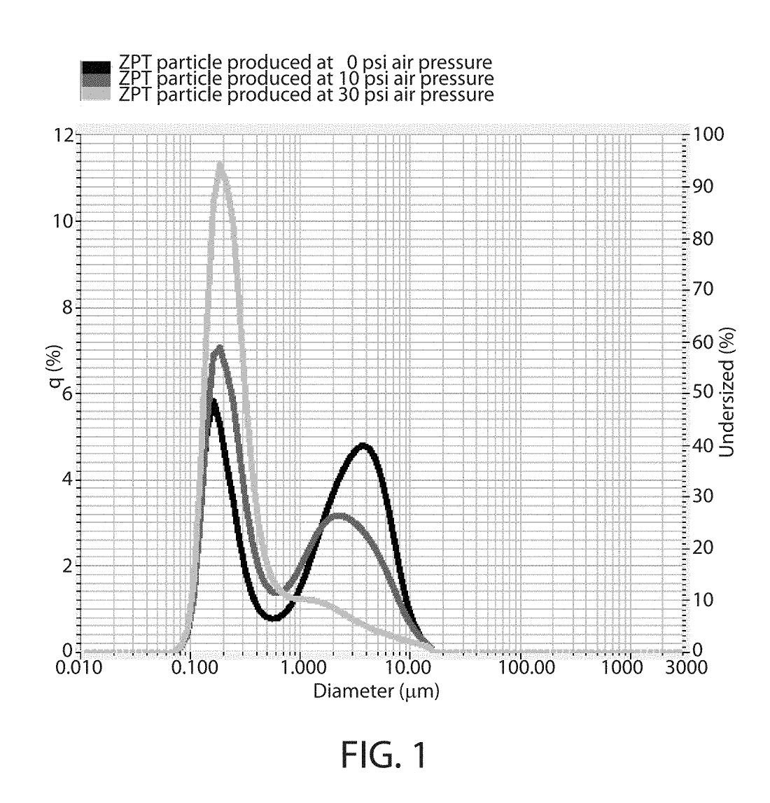

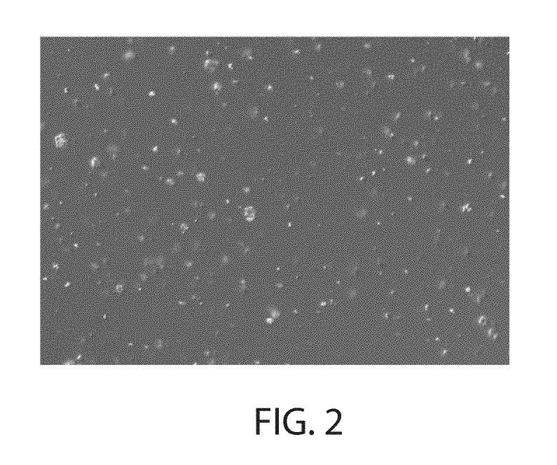

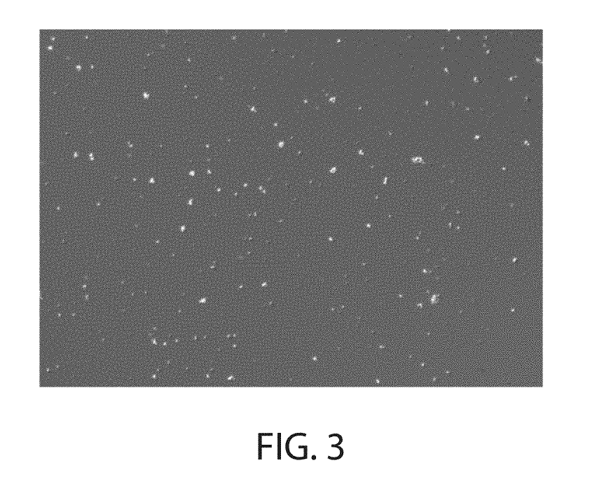

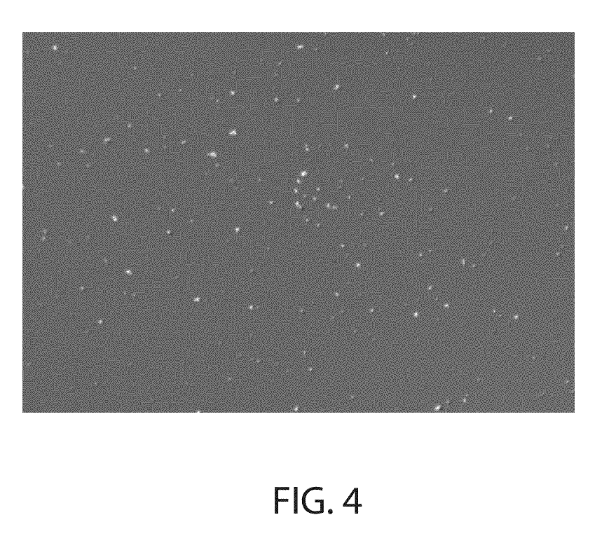

Based on the density of the resulting foam created at about 30 psi relative to the material created at an air pressure of about 0 psi, the foamed material has an air volume fraction of about 60%. The details of the particle-size distributions, including the Horiba parameters used and the reduction in prevalence of particles greater than 1 micron with increasing air pressure, can be found in FIG. 1. Cross-polar optical microscopy of these three samples, taken with a Zeiss Axioscope microscope with a 10× magnification camera and 40× magnification objective, can be found in FIGS. 2, 3 and 4.

### Example 2

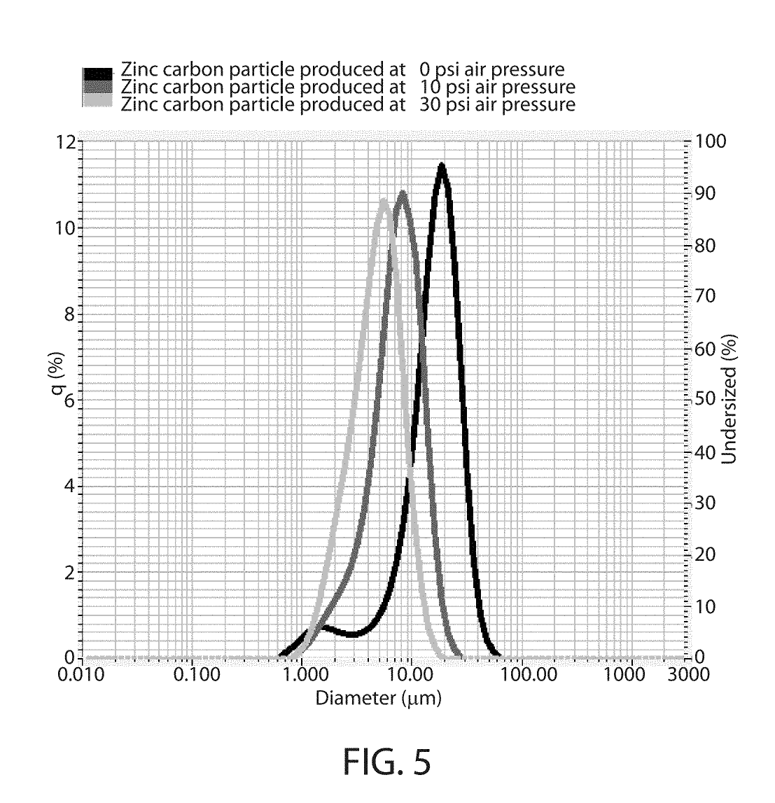

An aqueous solution of about 30% zinc sulfate and about 1% active sodium laureth sulfate by weight is pumped via syringe pump to one incoming branch of a 6-cm inner diameter tee at about 100 g/min. Compressed air at air pressures of about 0 to about 30 psi is permitted to enter the second incoming branch of the tee through a Grreat Choice™ aquarium airstone frit, and the outlet of the tee is connected to 12 elements of 6-mm SMX static mixer. The foam downstream of the static mixer is combined with a tee junction into a IKA Magic Lab rotor-stator mill, where the second inlet to the tee into the mill is connected to a 6-cm pipe conveying about 123 g/min of an about 10% sodium carbonate solution trimmed with hydrochloric acid to a pH of about 10.5, wherein the sodium carbonate solution is delivered using a second syringe pump. The contact point of the two streams is placed just upstream of the high-shear zone of the mill, which is operated at a speed of about 15000 rpm. The particle containing mixture downstream of the mill is collected and sampled into a sodium laureth sulfate solution for particle size analysis on a Horiba LA-950 particle-size analyzer. The volume-averaged particle sizes, using the Horiba refractive-index parameters indicated in FIG. 5 are as follows:

| Air pressure | Median particle size |
|---|---|
| 0 psi | 16.543 μm |
| 10 psi | 7.451 μm |
| 30 psi | 4.8765 μm |

Based on the density of the resulting foam created at about 30 psi relative to the material reacts at about 0 psi, the foamed material has an air volume fraction of about 70%. The details of the particle-size distributions can be found in FIG. 5.

### Example 3

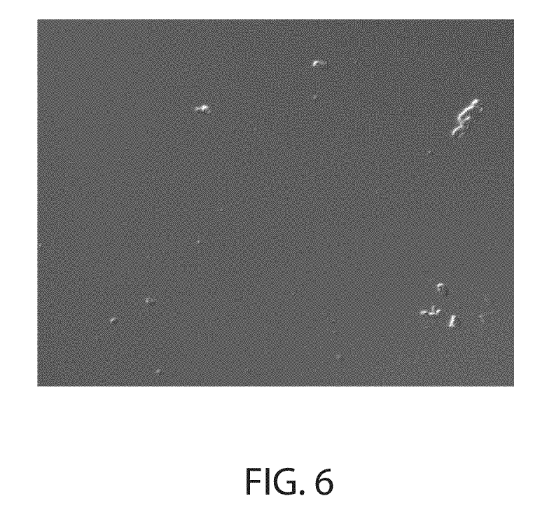

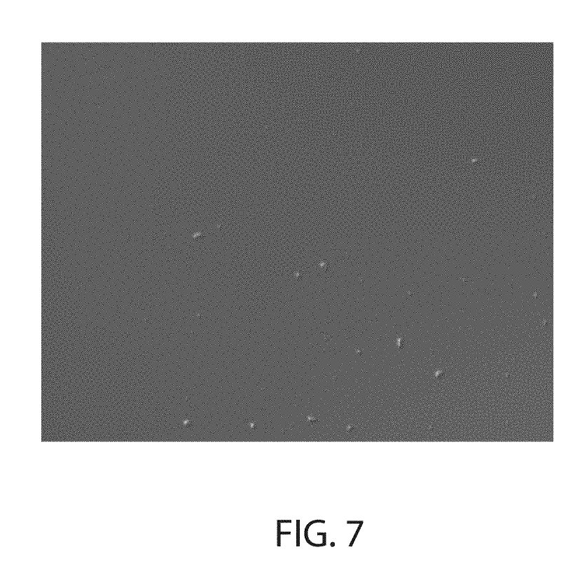

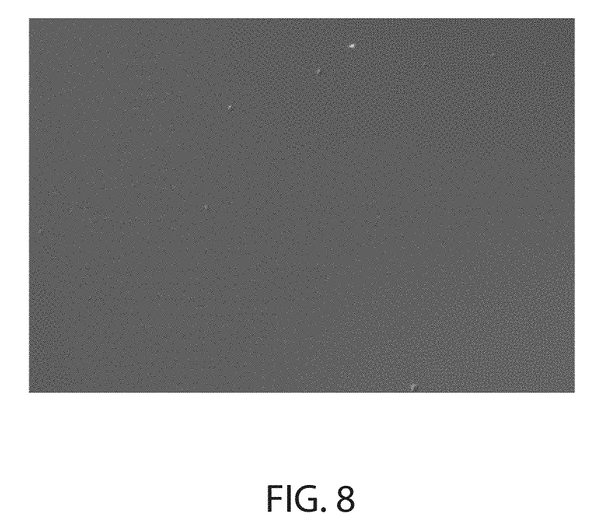

An aqueous solution of about 25% active sodium laureth sulfate by weight is delivered via syringe pump to one incoming branch of a tee at about 180 g/min. Compressed air at air pressures of about 0 psi is permitted to enter the second incoming branch of the tee through a Grreat Choice™ aquarium airstone frit, and the outlet of the tee is connected to 12 elements of 6-mm SMX static mixer. The foam downstream of the static mixer combined with a tee junction into a IKA Magic Lab rotor-stator mill, where the second inlet to the tee into the mill is connected to an about 60 g/min of an about 10% by weight solution of polyquaternium-6 (Mirapol 100S, Solvay, Orange, Tex., USA). The contact point of the two streams is placed just upstream of the high-shear zone of the mill, which is operated at a speed of about 15000 rpm. Next about 2 grams of the material downstream of the mill is mixed into about 200-g of a composition containing about 15% sodium laureth sulfate and about 0.8% cocamidopropyl betaine, which is then homogenized on a Flacktek (Landrum, S.C., US) speedmixer at about 800 rpm for about one minute to form a personal care product. Based on the density of the resulting foam created at 30 psi relative to the material reacted at about 0 psi, the foamed material has an air volume fraction of about 55%. The experiment is then repeated with an air pressure of about 10 psi instead of about 0 psi, and again at an air pressure of about 30 psi. Comparative cross-polar microscopy of samples imaged on a Zeiss Axioscope at 400× are included as FIG. 6 for the 0-psi sample, FIG. 7 for the about 10-psi sample, and FIG. 8 for the about 30-psi sample. Note the qualitative reduction in particle size with the increased air pressure.

### Example 4

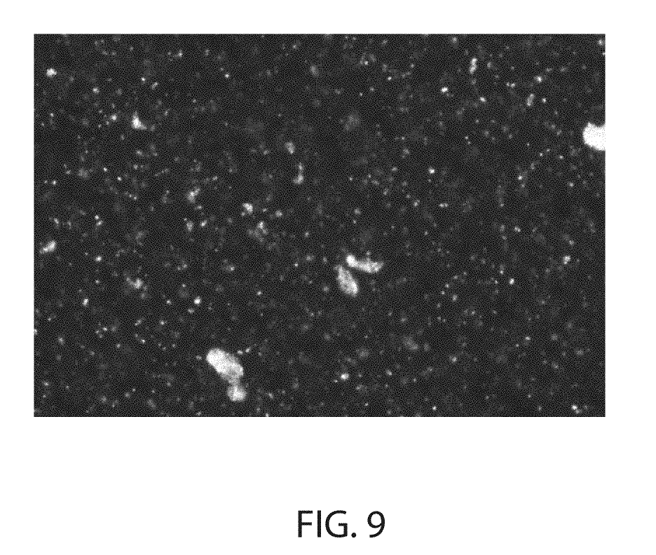

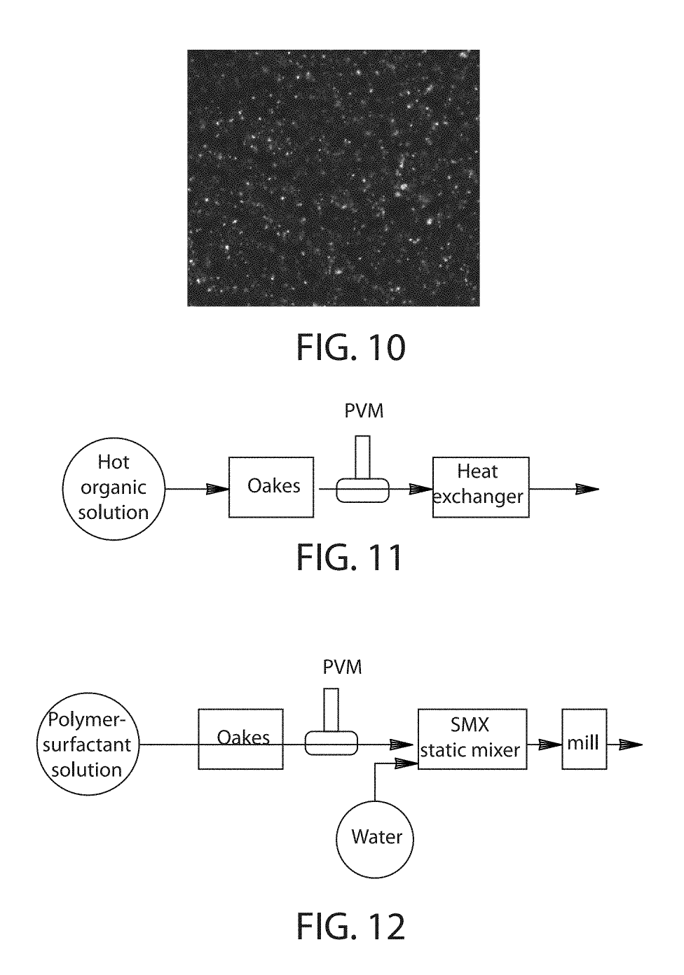

An about 49% solution of sodium pyrithione, available from Kolon Chemicals (South Korea), is pumped to one incoming branch of a tee at about 300 g/min using a syringe pump. Compressed air at an air pressure of about 5-10 psi is permitted to enter the second incoming branch of the tee, and the outlet of the tee is connected to 12 elements of 6-mm SMX static mixer. The foam downstream of the static mixer is teed into 6-element, 10-mm Kenics static mixer (Chemineer, Dayton, Ohio, US), where the second inlet to the tee is connected to an about 150 g/min stream of Mirapol 100S polyquaternium-6 diluted with water to about 3.15% active polymer by weight. The material downstream of the Kenics static mixer is dispersed into a composition containing about 12% sodium laureth sulfate, about 1.5% cocamidopropyl betaine, about 0.15% polyquaternium-10, about 1.5% ethylene glycol stearate, and sodium chloride to a viscosity of about 8000 cP, then mixed at about 1900 rpm for about four minutes to form a personal care product. This final composition is imaged at 400× under cross-polar microscopy with a Zeiss Axioscope in FIG. 9. This experiment is repeated at an air pressure of about 20 psi, with the resulting 400× cross-polar image included as FIG. 10. The higher air pressure corresponds to a greater volume fraction of air in the ZPT mixture prior to the contact with the DADMAC stream, and therefore a reduction in the generation of less than about 10 μm particles, as shown in FIGS. 9 and 10.

### Example 5: Method of Making Pigments with Controlled Particle Size

The process described herein can be used for the continuous manufacturing of insoluble organic pigments having controlled particle size. The organic pigment manufactured by the process can be an azo pigment, made by the reaction of a diazo compound of an aromatic amine and a coupler compound via an aromatic electrophilic substitution reaction.

The process of making azo pigment can comprise the following steps:

A. Preparation of Diazo Compound
1. An aqueous suspension of about 1512 g of 3,3′-dichlorobenzidine (Compound I) in about 2200 g of 9N hydrochloric acid is diazotized by adding about 2120 g of an about 40% sodium nitrite solution at about 0° C. for about 30 minutes. The temperature is kept at this temperature by addition of ice.
2. The excess nitrite is destroyed by addition of the appropriate amount of sulfamic acid.

B. Preparation of the Coupler Solution
1. A solution is prepared by mixing about 1720 g acetoacetylxylidide (Compound II) with about 1650 g of an about 30% sodium hydroxide solution and about 40000 g deionized water.
2. An amount of about 1400 g of sodium lauryl sulfate solution (about 70% active) is added and mixed to aerate.

### Coupling Reaction

1. The aerated coupler solution is fed (at about 100 g/minute) into the line of a 1-liter single stage reactor fitted with additional feed lines and a single discharge line. Each feed line is equipped with a pump and a high speed impeller.
2. The diazo compound is fed to another feed line (at about 90 g/minute). The coupling reaction takes place at room temperature and at pH of about 6.0.
3. The manufactured yellow pigment is continuously discharged.
4. Optionally, a silicone defoamer is added to the discharged pigment slurry, which is then
5. Filtered (or centrifuged) and
6. Washed with water to remove the excess soluble salts and other impurities.

A control pigment is manufactured by a similar process but without aeration of the couple. The particles size of the material manufactured from the inventive aerated process is significantly smaller than that manufactured by the control process, leading to improved color strength and brightness.

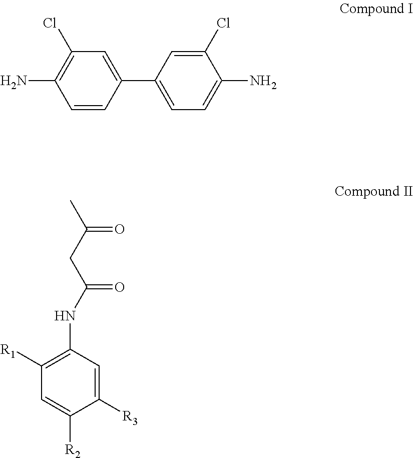

(for Example 5, R1 and R2 are both methyl groups)

### Reaction Scheme of Example 5

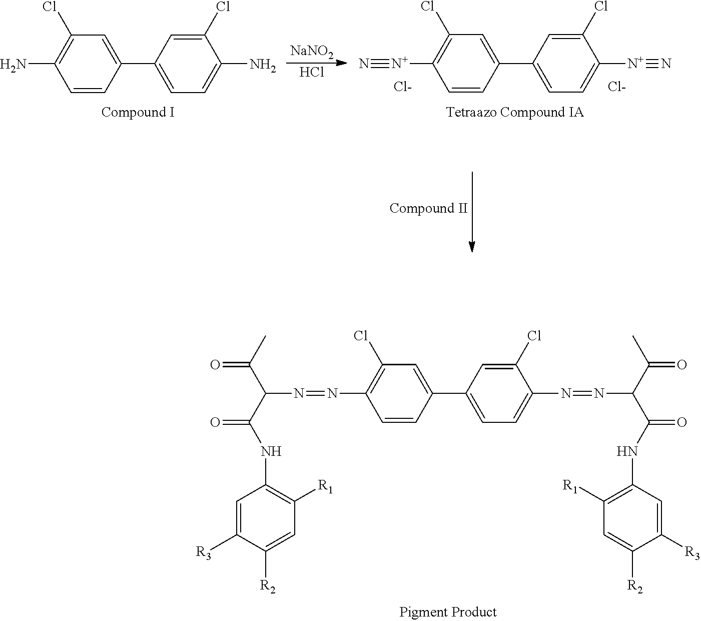

Defoamer or foam-breaker material

The process can include mixing the gas-liquid mixture containing the produced particles downstream with a defoamer material, which reduces or removes the gas component of the mixture and facilitates the isolation and storage of the produced particles. The defoamer material can be selected from the following classes:
a. Nonionic surfactants such as acetylenic diols;
b. Powder defoamers, such as silica particles, hydrophobically modifies or unmodified;
c. Oil defoamers, such as mineral oils, vegetable oils, or other types of oil, which are insoluble in the liquid stream carrier;
d. Waxes in oil carrier; the wax can be selected from paraffins, fatty esters, fatty alcohols, fatty acids, and other materials;
e. Silicone fluid emulsions;
f. Polyethylene glycols or polypropylene glycols or polyethylene-polypropylene copolymers or mixtures thereof;
g. Other polymeric materials such as polyacrylate homopolymer or copolymers.

### Example 6: Method of Making Fatty Alcohol Particles of Controlled Size, as a Proxy for Pharmaceutical Applications

An amount of about 270 g of laureth-4 (Croda Inc., New Castle, Del., USA) is charged to a stirred, jacketed vessel and heated to about 75° C., followed by addition of about 30 g of behenyl alcohol (BASF Corporation). After a period of about 5 minutes to melt the behenyl alcohol and blend it into the laureth-4, the homogenized solution is pumped at about 50 grams per minute as depicted in FIG. 11 into an Oakes (Hauppauge, N.Y., US) 2M1A foam generator to foam at a targeted density of about 0.45 g/ml, using nitrogen as the gas supply. The outlet of the foam generator is connected to a pipe containing a Mettler Toledo Particle Video Microscope (PVM, Model V19) to obtain digital images of the foam for assessing the bubble size. A shell-and-tube heat exchanger is placed at the outlet of the pipe containing the PVM. Water at about 10° C. and about 300 g/min is pumped through the shell side of the heat exchanger to cool the mixture of laureth-4 and behenyl alcohol to about 30° C., which is collected and imaged at 400× magnification on a Zeiss Axioscope to estimate the size of the crystals formed. For comparative purposes, the experiment is repeated at an increased targeted foam density of about 0.9 g/mL.

### Example 7: Method of Making Coacervate Particles of Controlled Size

An amount of about 0.5 gram of JR30M polyquaternium-10 (Amerchol Corp, Greensburg, S.C., US) is dispersed into about 190 grams of water with an overhead impeller mixer at about 200 rpm, and allowed to mix for about 5 minutes at about 200 rpm, followed by addition of about 800 grams of about 26% by weight solution of sodium laureth-1 sulfate (Stepan, Matamoros, Mexico) and about 10 grams of sodium chloride while continuing to mix at about 20° C. The homogenized polymer surfactant solution is pumped at about 200 grams into an Oakes 2M1A foam generator to foam at a targeted density of about 0.4 g/ml, as depicted in FIG. 12, using compressed air as the gas supply. The outlet of the static mixer is connected to a pipe containing a Mettler Toledo Particle Video Microscope (PVM; Model V19) to obtain digital images of the foam for assessing the bubble size. The outlet of this pipe leads to a tee connection into 6 elements of 6-mm SMX static mixer, and water at a flow rate of about 200 grams per minute is permitted to enter the static mixer through the other inlet to the tee connection. The outlet of the pipe containing the SMX static mixer is connected to an IKA Magic Lab rotor-stator mill that is rotating at about 15,000 rpm. About 500 grams of the material exiting the mill is collected in a 1-liter vessel equipped with an overhead agitator at about 50 rpm. After allowing about 10 minutes of gentle mixing to deaerate the bulk liquid, a Lasentec FBRM (Mettler-Toledo, Columbus Ohio) is inserted into the bulk liquid to measure the particle size of the coacervate particles. The mean-square weight of the chord length is reported as the relative particle size of the coacervate particles. For comparative purposes, the experiment is repeated at an increased targeted foam density of about 0.9 g/mL.

A. A method of making solid particles comprising:
a) adding a precursor material to a liquid to form a liquid stream, wherein the concentration of precursor material is from about 2% to about 99% by weight of the liquid stream;
b) adding an inert gas stream into the liquid stream of step a, resulting in a gas-liquid mixture having a gas volume fraction from about 30% to about 98% and an average Sauter mean bubble diameter of about 0.2 to about 200 μm;
c) transforming the precursor material physically or chemically, resulting in the formation of solid particles.
   B The method of Paragraph A, wherein the inert gas is selected from the group consisting of air, oxygen, nitrogen, argon, carbon dioxide, volatile hydrocarbons, and mixtures thereof.
   C. The method of Paragraph A-B, wherein the liquid is an aqueous carrier, and wherein the aqueous carrier comprises from about 50% to about 100% water.
   D. The method of Paragraph A-C, wherein the liquid stream comprises a dissolved precursor material with a chemical structure that is the same as the chemical structure of the solid particles of step c, and wherein the transformation of the precursor material of step c is physical transformation.
   E. The method of Paragraph A-D, wherein the physical transformation is initiated by a change selected from the group consisting of temperature, pressure, an addition of a liquid, an addition of seed solid particles, an addition of a salt, an evaporation of a portion of the liquid stream comprising the precursor material, and combinations thereof.
   F. The method of Paragraph A-E, wherein step c involves a chemical change between the precursor material and a reagent added as a component of an additional stream into the gas-liquid mixture.
   G. The method of Paragraph A-F, wherein the reagent is added into the gas-liquid mixture as a neat liquid or in powder form.
   H. The method of Paragraph A-G, wherein the reagent is added into the gas-liquid mixture as a gas.
   I. The method of Paragraph A-H wherein the liquid stream comprising a precursor material is an aqueous solution or dispersion of material selected from the group consisting of (a) acetoacetanilide, (b) a derivative of acetoacetanilide and (c) a phenol derivative and the reagent is a solution or dispersion of a diazo or tetraazo compound of an aniline derivative, producing diazo pigment particles or diazo dye particles.
   J. The method of Paragraph A-I, wherein the aniline derivative is 3,3′-dichlorobenzidine and the acetoacetanilide or the acetoacetanilide derivative precursor material is a material that can be represented by the following chemical structure

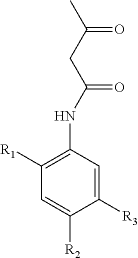

wherein R₁, R₂ and R₃ can be a selected from the groups consisting of —H, —Cl, methyl, and methoxy group, and
wherein R₁, R₂ and R₃ can be the same or different functional groups.
K. The method of Paragraph A-J, wherein the aniline derivative material can be represented by the following chemical structure

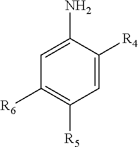

wherein R₄, R₅ and R₆ can be a selected from the groups consisting of —H, —Cl, methyl, methoxy, —SO₃M, —CO—NH₂, and —NO₂
and wherein R₄, R₅ and R₆ can be the same or different functional groups,
and wherein M can be selected from —H and alkali metal ion;
and wherein the phenol derivative can be represented by the following chemical structure:

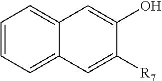

wherein R₇, can be a selected from the groups consisting of —H, —COOM, and COR₈,
and wherein R₈ can be represented by the chemical formula

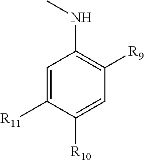

wherein R₉, R₁₀, R₁₁ can be selected from the group containing —H, —Cl, methyl, methoxy and ethoxy,
And wherein R₉, R₁₀, R₁₁ can be the same or different functional groups,
and wherein M can be selected from —H and alkali metal ion.
L. The method of Paragraph A-K, wherein the diazo dye particles are mixed downstream with an aqueous inorganic salt solution.
M. The method of Claim Paragraph A-L, wherein the aqueous inorganic salt solution is selected from a group consisting of calcium, magnesium, strontium and barium salt.
N. The method of Paragraph A-M, wherein the liquid stream comprising the precursor material initially contains from about 2% to about 50% by weight of a soluble salt of calcium, copper, magnesium, or zinc.
O. The method of Paragraph A-N, where the solid particles have a maximum dimension of between about 0.1 and about 100 μm.
P. The method of Paragraph A-O, where the solid particles have a maximum dimension of between about 0.2 and about 10 μm.
Q. The method of Paragraph A-P, wherein step c begins in less than 10 seconds after step b in the continuous process.
R. The method of Paragraph A-Q, where the gas volume fraction at the initiation of the transformation is between 40% and 90%
S. The method of Paragraph A-R, where the resulting solid particles comprise an organic material and have about 10% to about 95% by weight of carbon.
T. The method of Paragraph A-S, wherein the total energy inputted to step c is less than 0.1 kJ per kg of solid particle formed.
U. The method of Paragraph A-T, where liquid stream comprising precursor material comprises a cationic polymer with charge density of about 1.0 to about 20 meq/gram.
V. The method of Paragraph A-U, controlling the gas phase bubble size of step b with static mixers or cavitation tubes.
W. The method of Paragraph A-V, initiating step c with a rotor-stator mixer.
X. The method of Paragraph A-W, further comprising d) separating the inert gas from the other components via a gas removal operation.
Y. The method of Paragraph A-X, wherein the removal operation includes application of vacuum, centrifugation, or the addition of a “foam breaker” to coalesce the gas into larger bubbles.
Z. The method of Paragraph A-Y, wherein step c is followed by a further step selected from the group consisting of filtration, dilution with a solvent, spray drying, vacuum, centrifugation and any combination thereof.
AA. The method of Paragraph A-I, wherein the liquid stream comprising a precursor material is an aqueous solution or dispersion of zinc salt and the reagent is sodium pyrithione.
BB. The method of Paragraph A-I, wherein the liquid stream comprising a precursor material is an aqueous solution or dispersion of sodium pyrithione and the reagent is an aqueous zinc salt solution.
CC. The method of Paragraph A-I, wherein the liquid stream comprising a precursor material is an aqueous solution or dispersion of zinc salt and the reagent is selected from the group consisting of carbon dioxide and carbonate anions.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making solid particles comprising:
a) adding a precursor material to a liquid to form a liquid stream, wherein the concentration of precursor material is from about 2% to about 99% by weight of the liquid stream;
b) adding an inert gas stream into the liquid stream of step a, resulting in a gas-liquid mixture having a gas volume fraction from about 30% to about 98% and an average Sauter mean bubble diameter of about 0.2 to about 200 μm;
c) transforming the precursor material physically or chemically, resulting in the formation of solid particles.

2. The method of claim 1, wherein the inert gas is selected from the group consisting of air, oxygen, nitrogen, argon, carbon dioxide, volatile hydrocarbons, and mixtures thereof.

3. The method of claim 1, wherein the liquid is an aqueous carrier, and wherein the aqueous carrier comprises from about 50% to about 100% water.

4. The method of claim 1, wherein the liquid stream comprises a dissolved precursor material with a chemical structure that is the same as the chemical structure of the solid particles of step c, and wherein the transformation of the precursor material of step c is physical transformation.

5. The method of claim 4, wherein the physical transformation is initiated by a change selected from the group consisting of temperature, pressure, an addition of a liquid, an addition of seed solid particles, an addition of a salt, an evaporation of a portion of the liquid stream comprising the precursor material, and combinations thereof.

6. The method of claim 1, wherein step c involves a chemical change between the precursor material and a reagent added as a component of an additional stream into the gas-liquid mixture.

7. The method of claim 6, wherein the reagent is added into the gas-liquid mixture as a neat liquid or in powder form.

8. The method of claim 6, wherein the reagent is added into the gas-liquid mixture as a gas.

9. The method of claim 6 wherein the liquid stream comprising a precursor material is an aqueous solution or dispersion of material selected from the group consisting of (a) acetoacetanilide, (b) a derivative of acetoacetanilide and (c) a phenol derivative and the reagent is a solution or dispersion of a diazo or tetraazo compound of an aniline derivative, producing diazo pigment particles or diazo dye particles.

10. The method of claim 9, wherein the aniline derivative is 3,3′-dichlorobenzidine and the acetoacetanilide or the acetoacetanilide derivative precursor material is a material that can be represented by the following chemical structure 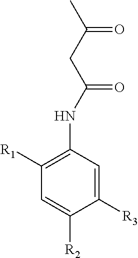
wherein R₁, R₂ and R₃ can be a selected from the groups consisting of —H, —Cl, methyl, and methoxy group, and
wherein R₁, R₂ and R₃ can be the same or different functional groups.

11. The method of claim 10, wherein the aniline derivative material can be represented by the following chemical structure 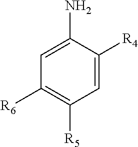
wherein R₄, R₅ and R₆ can be a selected from the groups consisting of —H, —Cl, methyl, methoxy, —SO₃M, —CO—NH₂, and —NO₂
and wherein R₄, R₅ and R₆ can be the same or different functional groups,
and wherein M can be selected from —H and alkali metal ion;
and wherein the phenol derivative can be represented by the following chemical structure: 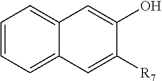
wherein R₇, can be a selected from the groups consisting of —H, —COOM, and COR₈,
and wherein R₈ can be represented by the chemical formula 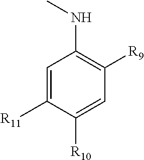
wherein R₉, R₁₀, R₁₁ can be selected from the group containing —H, —Cl, methyl, methoxy and ethoxy,
And wherein R₉, R₁₀, R₁₁ can be the same or different functional groups,
and wherein M can be selected from —H and alkali metal ion.

12. The method of claim 9, wherein the diazo dye particles are mixed downstream with an aqueous inorganic salt solution.

13. The method of claim 12, wherein the aqueous inorganic salt solution is selected from a group consisting of calcium, magnesium, strontium and barium salt.

14. The method of claim 1, wherein the liquid stream comprising the precursor material initially contains from about 2% to about 50% by weight of a soluble salt of calcium, copper, magnesium, or zinc.

15. The method of claim 1, where the solid particles have a maximum dimension of between about 0.1 and about 100 μm.

16. The method of claim 15, where the solid particles have a maximum dimension of between about 0.2 and about 10 μm.

17. The method of claim 1, wherein step c begins in less than 10 seconds after step b in the continuous process.

18. The method of claim 1, where the gas volume fraction at the initiation of the transformation is between 40% and 90%

19. The method of claim 1, where the resulting solid particles comprise an organic material and have about 10% to about 95% by weight of carbon.

20. The method of claim 1, wherein the total energy inputted to step c is less than 0.1 kJ per kg of solid particle formed.

21. The method of claim 1, where liquid stream comprising precursor material comprises a cationic polymer with charge density of about 1.0 to about 20 meq/gram.

22. The method of claim 1, controlling the gas phase bubble size of step b with static mixers or cavitation tubes.

23. The method of claim 1, initiating step c with a rotor-stator mixer.

24. The method of claim 1, further comprising d) separating the inert gas from the other components via a gas removal operation.

25. The method of claim 24, wherein the removal operation includes application of vacuum, centrifugation, or the addition of a “foam breaker” to coalesce the gas into larger bubbles.

26. The method of claim 1, wherein step c is followed by a further step selected from the group consisting of filtration, dilution with a solvent, spray drying, vacuum, centrifugation and any combination thereof.
